(19) United States
(12) Patent Application Publication
(10) Pub. No.: US 2026/0296292 A1
(43) Pub. Date: Oct. 1, 2026

(54) VEHICLE STORAGE COMPARTMENT

(71) Applicant: MERCEDES-BENZ GROUP AG, Stuttgart (DE)

(72) Inventor: Karl DOLINSKY, Deckenpfronn (DE)

(21) Appl. No.: 19/476,014

(22) PCT Filed: Apr. 5, 2024
(86) PCT No.: PCT/EP2024/059280

§ 371 Date: Oct. 16, 2025

(30) Foreign Application Priority Data
Apr. 17, 2023 (DE) 10 2023 001 532.6

(51) Int. Cl. B60N 3/10

(52) U.S. Cl. CPC B60N 3/106

(57) ABSTRACT

A vehicle storage compartment has a lower storage space, an upper storage space, and a separating device between the lower storage space and the upper storage space. The separating device has at least one separating element having a first limb and a second limb, which is arranged perpendicular to the first limb and is fixedly connected to the first limb via a hinged joint. The at least one separating element is rotatable by a rotation mechanism about the hinged joint in such a way that the two limbs of the separating element are positionable between a horizontal position and a vertical position. In its horizontal position between the lower storage space and the upper storage space, the first limb of the at least one separating element extends at least over half the width of the storage compartment.

### BACKGROUND AND SUMMARY OF THE INVENTION

Exemplary embodiments of the invention relate to a vehicle storage compartment.

Storage compartments are provided in vehicles for receiving and storing objects in various configurations and embodiments, for example as drinks holders for receiving beverage receptacles such as beverage bottles or the like.

DE 10 2008 029 259 A1 describes a receiving element for a vehicle, having a housing that is open at the top for receiving at least one receptacle. The housing has at least one lateral clamping element and a rotatable support with two pivotably connected support parts that can be rotated towards each other like a toggle lever.

Furthermore, US 2006/0037984 A1 discloses a holding structure in a vehicle for receiving containers of different size. To this end, a partition wall element having a second base which is positioned above a first base is provided.

Exemplary embodiments of the invention are directed to a vehicle storage compartment, in the case of which it is easily and advantageously possible to receive different objects in a variable manner.

In the vehicle storage compartment according to the invention, the separating device is formed between the lower storage space and the upper storage space by at least one rotatable separating element.

The at least one separating element that can be rotated by means of a rotation mechanism has two limbs arranged perpendicular (orthogonal) to one another and fixedly connected to one another via a hinged joint.

The two limbs of the at least one separating element assume either a horizontal position or a vertical position as a result of a corresponding rotational movement of the separating element, i.e., if the first limb of the at least one separating element is positioned in the horizontal position, the second limb of the at least one separating element is positioned in the vertical position, and vice-versa.

In particular, the first limb of the at least one separating element is positioned in its horizontal position between the lower storage space and the upper storage space of the storage compartment.

The lengths of the two limbs of the at least one separating element are selected in this case based on the dimensions of the storage compartment. In particular, the length of the first limb of the at least one separating element is selected such that, in its horizontal position between the lower storage space and the upper storage space, the first limb of the at least one separating element extends in the transverse direction (y direction) of the storage compartment at least over half the width of the storage compartment, thereby forming a support surface between the lower storage space and the upper storage space.

For example, depending on the extent and size of the storage compartment, up to six such rotatable separating elements are provided as a separating device between the lower storage space and the upper storage space, which separating elements are arranged spaced apart from one another in the longitudinal direction (in the x direction) of the storage compartment and are rotated at the same time and in the same direction by means of the rotation mechanism. In their horizontal position between the lower storage space and the upper storage space, the first limbs of these separating elements extend in the transverse direction (y direction) of the storage compartment at least over half the width of the storage compartment, thereby forming a compact support surface between the lower storage space and the upper storage space.

The rotational movement of the at least one rotatable separating element that consists in particular of plastic is preferably realized via a hinged joint with plastic axles or metal axles, for example via a pivot joint or an appropriately configured hinge.

In an advantageous refinement of the invention, a spring-loaded mechanism is provided as an opening mechanism and/or closing mechanism, which fixes the two limbs of the rotatable separating element in the respective end position, i.e., on the one hand, in the horizontal position of the first limb of the separating element and simultaneously in the vertical position of the second limb of the separating element and, on the other hand, in the vertical position of the first limb of the separating element and simultaneously in the horizontal position of the second limb of the separating element.

In the same way, the two limbs of the rotatable separating element can be released from the respective end position via this spring-loaded mechanism as an opening mechanism.

In order to lock the two limbs of the at least one rotatable separating element in place in the respective end position, a latching mechanism can moreover be provided as a fastening mechanism. For example, to this end, a latching element for latching the respective limb of the at least one separating element is formed on the side wall of the storage compartment or in a recess in the side wall of the storage compartment. In other words, either the respective limb of the at least one separating element bears in the vertical position against the side wall of the storage compartment and is latched there or the respective limb of the at least one separating element is received by the side wall of the storage compartment and is latched there.

In an advantageous refinement of the invention, the rotation mechanism for the at least one rotatable separating element can be activated by actuating a control element which is arranged, for example, adjacent to the storage compartment.

This control element can be a push button, toggle switch, or rotary switch, for example, and can be actuated by a vehicle occupant in order to carry out or activate the rotational movement of the at least one rotatable separating element between the horizontal position or vertical position of the two limbs of the separating element and the vertical position or horizontal position of the two limbs of the separating element.

In the horizontal position of the first limb of the at least one rotatable separating element, a fixed intermediate shelf is thus formed as a separating device and support surface between the lower storage space and the upper storage space of the storage compartment in a first use position of the separating device; in the vertical position of the first limb of the at least one rotatable separating element, a large storage volume formed in the vertical direction (in the z direction) of the storage compartment is provided in the storage compartment in a second use position of the separating device.

As a result, in the second use position of the separating device and hence in the vertical position of the first limb of the at least one rotatable separating element, in particular also a large-size and bulky beverage bottle can in particular also be accommodated as a beverage receptacle in the storage compartment.

The lower storage space of the storage compartment preferably has a lateral access opening, so that the contents of the lower storage space of the storage compartment can also be accessed by a user of the vehicle when the first limb of the at least one rotatable separating element is in a horizontal position.

The storage compartment can be arranged at any suitable place in the vehicle, in particular where simple and favorable access for an operator of the vehicle is also possible.

To this end, the storage compartment is preferably arranged in the center console of the vehicle or in an armrest of the vehicle or in the door lining of the vehicle

With the above-presented vehicle storage compartment according to the invention, the storage space provided by the storage compartment can advantageously and easily be configured in a variable manner and reconfigured between the two use positions and thus easily adapted to the needs and requirements of a user.

Further advantages, features and details of the invention become apparent from the following description of a preferred exemplary embodiment and with reference to the drawing(s). The features and feature combinations mentioned above in the description and the features and feature combinations mentioned hereinafter in the description of the figures and/or shown alone in the figures can be used not only in the respectively given combination, but also in other combinations or in isolation, without departing from the scope of the invention.

### BRIEF DESCRIPTION OF THE DRAWING FIGURES

In the figures:

FIG. 1 shows a schematic representation of the storage compartment with rotatable separating elements in a first position of the separating elements;

FIG. 2 shows a schematic representation of the storage compartment in an alternative position of the separating elements;

FIG. 3 shows a sectional illustration with an excerpt of the storage compartment with rotatable separating elements.

### DETAILED DESCRIPTION

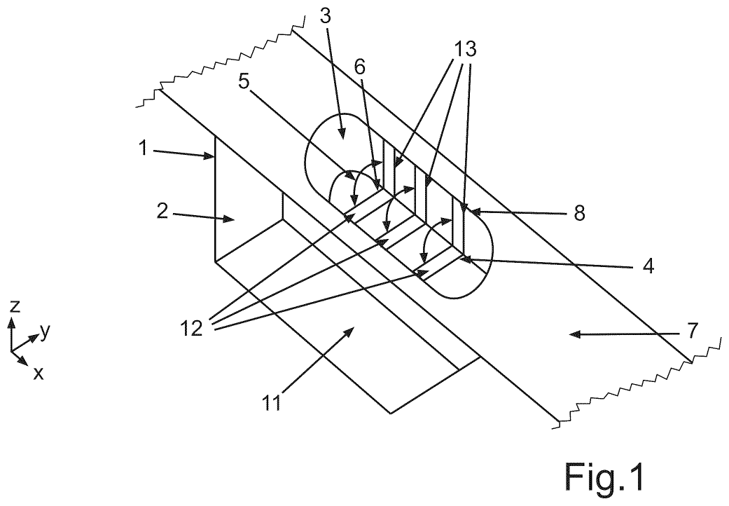

The storage compartment 1 schematically represented in FIG. 1 is made in the center console 7 of a vehicle, for example. The storage compartment 1 has, for example, an extent of approx. 150 mm to 200 mm in the longitudinal direction (x direction) and an extent of approx. 75 mm in the transverse direction (y direction).

The storage compartment 1 has a lower storage space 2 having a lateral access opening 11 that can be accessed by an operator and an upper storage space 3 that can be accessed by an operator from the top side of the storage compartment 1.

The separating device 4 is located between the lower storage space 2 of the storage compartment 1 and the upper storage space 3 of the storage compartment 1. This separating device 4 is formed by, for example, three rotatable separating elements 6 arranged spaced apart from one another in the longitudinal direction (x direction) of the storage compartment 1. These, for example, L-shaped rotatable separating elements 6 are designed, for example, as a plastic injection-molded part and for this purpose consist, for example, of thermoplastic acrylonitrile butadiene styrene (ABS). Additionally, a surface coating can also be provided on the plastic material of the rotatable separating elements 6, for example a chrome-plated surface layer on the plastic material, in particular also for design purposes or advertising purposes.

The three L-shaped or angled rotatable separating elements 6 in each case have a first limb 12 and a second limb 13, which are arranged orthogonal to each other and are rigidly connected to each other via the pivot joint 10.

According to FIG. 1, the first limbs 12 of the rotatable separating elements 6 are in a horizontal position in a first use position and thereby form a stable partition layer or support layer between the lower storage space 2 of the storage compartment 1 and the upper storage space 3 of the storage compartment 1.

By means of the rotation mechanism 5, the three L-shaped rotatable separating elements 6 that are arranged spaced apart from one another in the longitudinal direction (x direction) of the storage compartment 1 can be rotated by 90°.

As a result, the first limbs 12 of the rotatable separating elements 6 are rotated from the horizontal position according to FIG. 1 into a vertical position and the second limbs 13 of the rotatable separating elements 6 are rotated from the vertical position according to FIG. 1 into a horizontal position in the wall 8 of the storage compartment. This removes the stable partition layer between the lower storage space 2 of the storage compartment 1 and the upper storage space 3 of the storage compartment 1, so that consequently a uniform, enlarged storage volume is formed in the storage compartment 1 in a second use position.

If the first limbs 12 of the three rotatable separating elements 6 that are arranged spaced apart from one another in the longitudinal direction (x direction) of the storage compartment 1 are rotated from this vertical position by 90° and thus from the second use position back into a horizontal position, a stable partition layer is once again formed between the lower storage space 2 of the storage compartment 1 and the upper storage space 3 of the storage compartment 1 in the first use position.

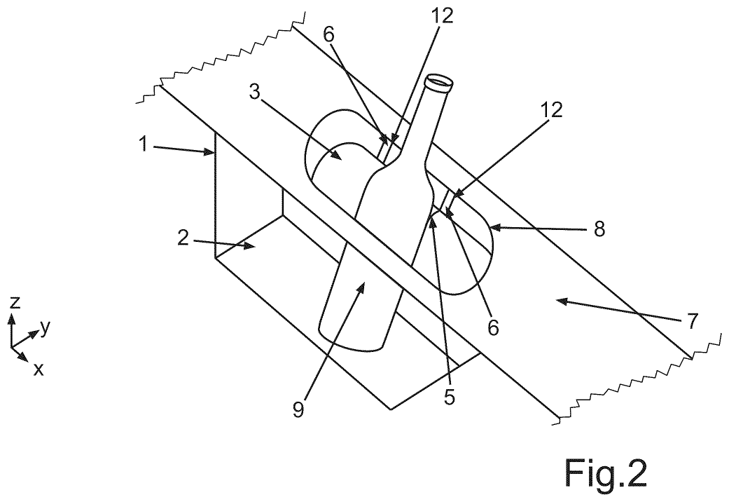

FIG. 2 shows the situation in which the first limbs 12 of the rotatable separating elements 6 are in a vertical position in the second use position, whereby the stable partition layer between the lower storage space 2 of the storage compartment 1 and the upper storage space 3 of the storage compartment 1 has accordingly also been removed. It is apparent from FIG. 2 that in the vertical position, the first limbs 12 of the rotatable separating elements 6 are received by the side wall 8 of the storage compartment 1 in which the first limbs 12 of the rotatable separating elements 6 are then latched and thus locked in place by means of latching elements of a fastening mechanism.

Forming the uniform, enlarged storage volume in the storage compartment 1 in the vertical position of the first limbs 12 of the rotatable separating elements 6, and thus in the second use position, also makes it possible to receive a (bulky) beverage bottle 9 in the storage compartment 1 without any problem.

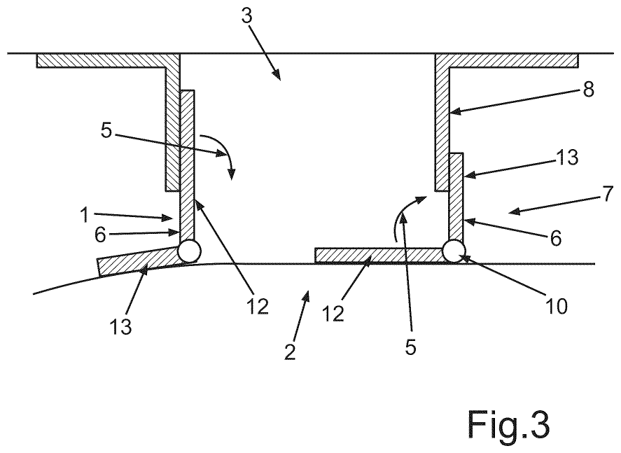

It is apparent from FIG. 3 that the rotation mechanism 5 for rotating the rotatable separating elements 6 from the first use position, with the formation of a stable partition layer between the upper storage space 3 of the storage compartment 1 and the lower storage space 2 of the storage compartment 1, into the second use position, with the formation of a large storage volume in the storage compartment 1, and vice versa from the second use position into the first use position is effected via the pivot joint 10 actuated by a rotation mechanism 5. This rotation mechanism 5 can in particular also be realized with an electric motor or mechanically by means of a spring mechanism.

Shown by way of example on the left side in FIG. 3 is a rotatable separating element 6 in the vertical and thus upwardly rotated position of the first limb 12. This first limb 12 of the rotatable separating element bears, for example, in the vertical and thus upwardly rotated position on the side wall 8 of the storage compartment 1 and is latched and thus locked in place there. The second limb 13 of the rotatable separating element 6 is in its horizontal position in the side wall 8 of the storage compartment 1 and can likewise be latched and thus locked in place there.

Shown by way of example on the right side in the FIG. 3 is a rotatable separating element 6 in the horizontal position of the first limb 12. This first limb 12 of the rotatable separating element 6 thus forms a stable partition layer between the upper storage space 3 of the storage compartment 1 and the lower storage space 2 of the storage compartment 1. The second limb 13 of the rotatable separating element 6 bears in its vertical position against the side wall 8 of the storage compartment 1 and can likewise be latched and thus locked in place there.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-10. (canceled)

11. A vehicle storage compartment comprising:
a lower storage space;
an upper storage space arranged above the lower storage space; and
a separating device arranged between the lower storage space and the upper storage space, wherein the separating device has at least one separating element having a first limb and a second limb, wherein the second limb is arranged perpendicular to the first limb and is fixedly connected to the first limb via a hinged joint,
wherein the at least one separating element is rotatable, via a rotation mechanism, about the hinged joint in such a way that the first and second limbs of the at least one separating element are positionable between a horizontal position and a vertical position, and
wherein, in a horizontal position of the first limb between the lower storage space and the upper storage space, the first limb extends at least over half a width of the vehicle storage compartment.

12. The vehicle storage compartment of claim 11, wherein the first limb and second limbs of the at least one separating element are lockable in place on a side wall of the vehicle storage compartment by a fastening mechanism.

13. The vehicle storage compartment of claim 11, wherein
in a vertical position of the first limb, the first limb is lockable in place in a recess in a side wall of the vehicle storage compartment by a fastening mechanism, and
in a vertical position of the second limb, the second limb is lockable in place in another recess in the side wall of the vehicle storage compartment by another fastening mechanism.

14. The vehicle storage compartment of claim 11, wherein the at least one separating element comprises a plastic material.

15. The vehicle storage compartment of claim 11, further comprising:
a control element configured to actuate the rotation mechanism.

16. The vehicle storage compartment of claim 11, wherein the rotation mechanism has a spring-loaded opening mechanism or a spring-loaded closing mechanism.

17. The vehicle storage compartment of claim 11, wherein in the vertical position of the first limb the vehicle storage compartment is configured as a beverage receptacle to receive at least one beverage bottle.

18. The vehicle storage compartment of claim 11, wherein the at least one separating element comprises a first and second separating element that are spaced apart from one another in a longitudinal direction of the vehicle storage compartment.

19. The vehicle storage compartment of claim 11, wherein the lower storage space of the vehicle storage compartment has a lateral access opening.

20. The vehicle storage compartment of claim 11, wherein the vehicle storage compartment is arranged in a center console of a vehicle.

21. A vehicle comprising:
at least one vehicle seat; and
a vehicle storage compartment arranged adjacent to the at least one vehicle seat, the vehicle storage compartment comprising
a lower storage space;
an upper storage space arranged above the lower storage space; and
a separating device arranged between the lower storage space and the upper storage space, wherein the separating device has at least one separating element having a first limb and a second limb, wherein the second limb is arranged perpendicular to the first limb and is fixedly connected to the first limb via a hinged joint,
wherein the at least one separating element is rotatable, via a rotation mechanism, about the hinged joint in such a way that the first and second limbs of the at least one separating element are positionable between a horizontal position and a vertical position, and
wherein, in a horizontal position of the first limb between the lower storage space and the upper storage space, the first limb of the at least one separating element extends at least over half a width of the vehicle storage compartment.
